(19) United States
(12) Patent Application Publication
(10) Pub. No.: US 2004/0032735 A1
(43) Pub. Date: Feb. 19, 2004

(54) Light source module with illumination uniformity

(76) Inventor: Hsiu-O Hsu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,798

(22) Filed: Aug. 19, 2002

(51) Int. Cl. F21V 1/00

(52) U.S. Cl. 362/240; 362/241; 362/800

(57) ABSTRACT

A light source module with illumination uniformity, suitable for use in a scanner. The light source module has a printed circuit board, multiple light emitting-diodes, and at least one light-collecting column. By installing reflection boards, or using a specially processed light-collecting column, the light-emitting diodes of the light source module can have the light source with an increase of the illumination as required.

### BACKGROUND OF INVENTION

1. Field of the Invention

The invention relates in general to a light-emitting diode light source module, and more particularly, to a light source module with enhanced uniformity.

2. Description of the Related Art

The continuous advancement of electronic techniques drives consumer electronic products to be developed with more powerful functions and faster processing speed. In addition, the consuming electronic products also tend to be thinner, lighter, shorter and smaller. This shrinkage, however, inevitably results in insufficiency in certain properties of some electronic products. For example, the brightness of a conventional light-source module such as a fluorescent lamp or cold cathode ray tube used in a scanner is consequently reduced, and the uniformity thereof is also normally poor. To increase the brightness of the light source module of the scanner, a light-emitting device is used as the light source. With the application of light-collecting equipment, a larger brightness of the scanned document or image in unit area can be obtained. For example, larger brightness can be achieved by replacing the conventional fluorescent lamp tube or cold cathode ray tube with the light-emitting diode array. Among several light-emitting diode arrays, the white light-emitting diode consumes less power but emits brighter light. Although brightness provided by the light-emitting diodes is superior to that provided by the conventional light source, it is insufficient for certain applications. Further, the non-uniformity of the light emitted from the light-emitting diodes is another issue which deteriorates the performance.

### SUMMARY OF INVENTION

The present invention provides a light source module of a scanner. In the light source module, second light-emitting diodes are inserted between any two neighboring first light-emitting diodes, while the brightness of the second light-emitting diodes is lower than that of the first light-emitting diodes. Therefore, the area with lower brightness is brightened, and the uniformity of the light source module is enhanced.

The present invention further provides a light source module of a scanner, in which a reflection board is disposed under each of the first light-emitting boards, such that the light emitted therefrom can be fully utilized; and consequently, the brightness of the light source module is increased. Further, being reflected by the reflection board, the light emitted from the first light-emitting diodes becomes more uniform.

The present invention further provides a light source module of a scanner, in which a light collecting board is disposed over the first and second light-emitting diodes, such that the brightness and the uniformity of the light source module are enhanced.

In one embodiment of the present invention, the light source module comprises a printed circuit board, a plurality of light-emitting diodes, at least one light-collecting board, and a plurality of reflection boards. The light-emitting diodes are disposed on the printed circuit board and electrically connected to the electrodes of the printed circuit board. One of the reflection boards is disposed between one of the light-emitting diodes and the printed circuit board. The light collecting board is disposed over the printed circuit board to cover the light-emitting diodes and the reflection boards.

Preferably, each of the reflection boards has at least one reflection surface, such that the light emitted from the light-emitting diodes, being reflected thereby, is randomly directed with improved uniformity.

Preferably, the light-emitting diodes comprise a plurality of first light-emitting diodes and a plurality of second light-emitting diodes alternately arranged on the printed circuit board. The second light-emitting diodes emit a light with lower brightness than that emitted from the first light-emitting diodes. In addition, the light-collecting board can be replaced with a plurality of light-collecting columns, and each of the light-collecting columns covers at least a row or a column of the light emitting diodes.

In another embodiment of the present invention, a light source module of the present invention is provided. The light source module comprises a printed circuit board, a plurality of light emitting diodes and a light-collecting board. The printed circuit board comprises a plurality of sets of electrodes, and the light emitting diodes are coupled to the electrodes. The light-collecting board is disposed over the printed circuit board to cover the light-emitting diodes and the electrodes. Alternatively, the light-collecting board can be replaced with a plurality of first light-collecting columns and second light-collecting columns alternately arranged between the printed circuit board and the light-emitting diodes, where the transmittance of the first light-collecting columns is higher than that of the second light-collecting columns.

Preferably, the first and second light-collecting columns are made of different injection materials to satisfy the limitation of transmittance. Alternatively, the second light-collecting columns may include a frosted surface to reduce the transmittance.

Both the foregoing general description and the following detailed description are exemplary and explanatory only and are not restrictive of the invention, as claimed.

### BRIEF DESCRIPTION OF DRAWINGS

FIG. 1 shows a cross-sectional view of a light-emitting diode light source module;

FIG. 2 shows the cross-sectional view of FIG. 1;

FIG. 3 shows the Gaussian distribution of the light emitted from the light-emitting diode array of the light source module as shown in FIGS. 1 and 2;

FIG. 4 shows the modified Gaussian distribution of the light emitted from the light source module with the application of the light-collecting columns;

FIG. 5 shows a cross sectional view of a light source module of a scanner according to one embodiment of the present invention;

FIG. 6 shows the relative allocation of a reflection board with respect to the light-emitting diodes;

FIG. 7 shows the brightness distribution as a function of position for two neighboring light-emitting diodes;

FIG. 8 shows a cross sectional view of a light source module of a scanner in another embodiment of the present invention; and

FIG. 9 shows the brightness curve as a function of position for two neighboring light-emitting diodes of the light source module as shown in FIG. 8.

### DETAILED DESCRIPTION

FIG. 1 shows a cross sectional view of a light source module with a light-emitting diode array suitable for use in a scanner. FIG. 2 shows a cross sectional view of FIG. 2. The light source module 100 comprises a plurality of light-emitting diodes 110, a printed circuit board 130 and a plurality of light-collecting columns 120. The light-emitting diodes 110 are arranged on the printed circuit board 130. Each of the light-emitting diodes 110 has two terminals 112, and the printed circuit board 130 has a plurality of electrodes 132 electrically connected to the terminals 112. The light-collecting columns 120 are disposed over the printed circuit board 130 to cover the light-emitting diodes 110. Preferably, the light-emitting diodes 110 are arranged as an array on the printed circuit board 130, where the array comprises a plurality of rows and columns of the light-emitting diodes 110.

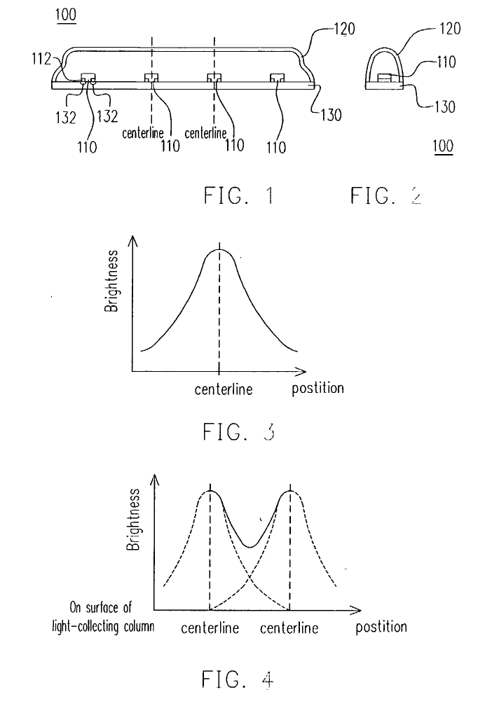

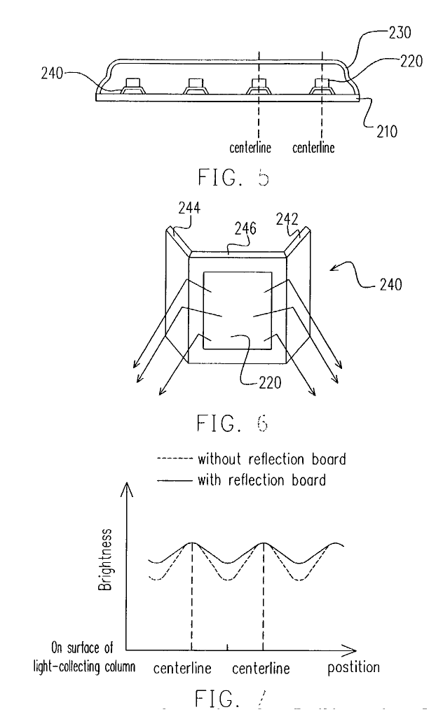

In FIG. 2, a cross sectional view of FIG. 1 is shown. In this embodiment, one of the light-collecting columns 120 covers at least one column or row of the light-emitting diodes 110. The centerline of the light-collecting column 120 is aligned over the centerlines of the light-emitting diodes 130 covered thereby. Referring to FIG. 3, the brightness of a single light-emitting diode 110 presents a Gaussian distribution with respect to the position thereof. As shown in FIG. 3, the maximum brightness is obtained at the centerlines of the light-emitting diodes 110 and the light-collecting column 120. In contrast, the minimum brightness is obtained at a periphery of the light-emitting diode 110. In FIG. 4, the brightness distribution versus positions of two neighboring light-emitting diodes 110 is illustrated. Again, maximum brightness can be obtained at the centerlines of the light-emitting diodes 110. However, at the peripheries of the light-emitting diodes 110, the brightness of both light-emitting diodes 110 superposed to result in a smooth profile. That is, the contrast between the bright area and the dark area defined by the light-emitting diodes 110 as well as the light-collecting columns 120 is suppressed.

FIG. 5 shows an improved design of the light source module of a scanner. The light source module comprises a printed circuit board 210, a plurality of light-emitting diodes 220, a light-collecting column 230, and a plurality of reflection boards 240. The printed circuit board 210 comprises a plurality of electrodes thereon (referred to FIG. 1). The light-emitting diodes 220 are allocated on the printed circuit board 210, and each of the light-emitting diodes 220 comprises one or more terminals, preferably two, electrically connected to the electrodes. The light-collecting column 230 is disposed on the printed circuit board 210 to cover the light-emitting diodes 220. The light-conducting and light-collecting features of the light-collecting column 230 allow the light emitted from the light-emitting diodes 220 to be made uniform.

In FIG. 5, only one row or column of the light-emitting diodes 220 are shown. It is appreciated that the light-emitting diodes 220 may also be arranged in a two-dimensional matrix or array which includes more than one row or column of light-emitting diodes 220. The array of the light-emitting diodes 220 can be covered with a single light-collecting board. Or alternatively, one light-collecting column 230 is applied to each column or row of the light-emitting diodes 220.

FIG. 6 shows an enlarged view of the allocation of one reflection board 240 with respect to the corresponding light-emitting diode 220. As shown in FIG. 5 and FIG. 6, the reflection boards 240 are located between the printed circuit board 210 and the light-emitting diodes 220. In this embodiment, the reflection board 240 has three continuous reflection surfaces 242, 244 and 246 oriented in or facing different directions. In FIG. 6, the side view of the reflection boards 240 shows a trapezium shape. The reflection surfaces 242 and 244 can reflect the light from the light-emitting diode 220 onto a left upper region or the right upper region. The reflected light can enhance the brightness between any two of the light-emitting diodes 220. As a result, the brightness at the region between two light-emitting diodes with respect to the light-collecting column 230 will be compensated. The illumination uniformity is then achieved.

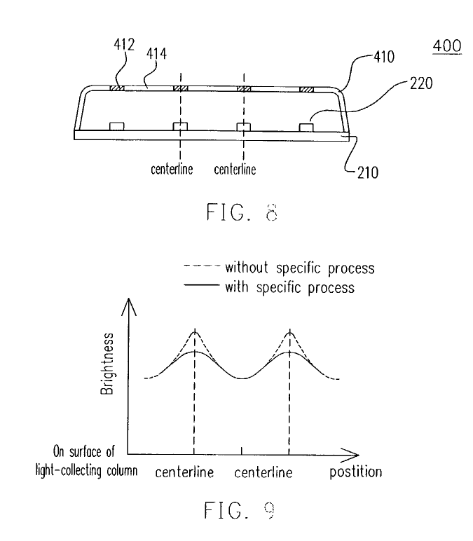

FIG. 7 shows the brightness distribution of the light emitted from the light source module with and without the introduction of the reflection board 240. Similar to FIG. 4, with the light-collecting column 230 only, the differential between the maximum brightness and the minimum brightness indicated by the dash line is significantly larger than that of both the light-collecting column 230 and the reflection boards 240. That is, the addition of the reflection boards 240 effectively suppresses the brightness contrast in various positions; and consequently, significantly enhances the uniformity of the light source module.

FIG. 8 shows another embodiment of a light source module. The light source module 400 includes a printed circuit board 210, a plurality of light-emitting diodes 220 and at least one light-collecting column 410. The allocation and connection are similar to the above embodiments. However, the light-collecting column 410 is so processed that the parts 412 thereof aligned over the centerline of the light-emitting diodes 220 that have smaller transmittance than that of the parts 414 other than the parts 412.

The light-collecting column 410 can be formed by injection of two different materials, where the material for forming the parts 412 has a transmittance smaller than that of the parts 414. Alternatively, both the parts 412 and 414 can be formed of the same material, while a process such as frosting is performed on the parts 412 to reduce the transmittance thereof.

FIG. 9 shows the brightness of the light emitted from a light source module. The dash line indicates brightness obtained from the light-collecting column 410 before being processed as shown in FIG. 1, while the solid line illustrates the brightness of the light-collecting column 410 after being processed as shown in FIG. 8. As shown in FIG. 9, by the light-collecting column with the forested surface or the dual-material ejection, the brightness above the light-emitting diode 220 can be reduced and the better illumination uniformity is achieved.

Accordingly, the present invention provides at least the following advantages:

1. By installing the reflection boards on the light-emitting diodes, without adding additional light-emitting diodes, the uniformity is enhanced, and the overall brightness is increased.

2. The frosted parts or dual-material ejection of the light-collecting column reduce the brightness above the light-emitting diode to improve the uniformity of the light emitted therefrom.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A light source module, comprising:
a printed circuit board, on which a plurality of electrodes are formed;
a plurality of light-emitting diodes disposed on the printed circuit board and electrically coupled together; and
at least one light-collecting column, disposed over the printed circuit board, and covering the light-emitting diodes, wherein the a surface of the light-collecting column has a plurality of first regions and a plurality of second regions, the first regions and the second regions are arranged alternatively on the light-collecting column, wherein a transmittance for the first regions is smaller than a transmittance for the second regions, and the first regions are located above the light emitting diodes.

2. The light source module according to claim 1, the first region is a forested surface.

3. The light source module according to claim 1, the first region includes a firt ejected material and the second region includes a second ejected material.

4. A light source module, suitable for use in a scanner, comprising:
a printed circuit board, on which a plurality of electrodes are formed;
a plurality of light-emitting diodes disposed on the printed circuit board and electrically coupled together;
at least one light-collecting column, disposed over the printed circuit board, and covering the light-emitting diodes; and
a plurality of reflection boards, disposed between the light-emitting diodes and the printed circuit board, so as to enhance a brightness at a region between the light emitting diodes.

5. The light source module according to claim 4, wherein each of the reflection boards comprises a plurality of reflection surfaces.

6. The light source module according to claim 4, wherein the reflection boards are used to reflect an incident light to a region between the the light-emitting diodes.
